(19) United States
(12) Patent Application Publication
(10) Pub. No.: US 2026/0200265 A1
(43) Pub. Date: Jul. 16, 2026

(54) WHEEL BEARING UNIT, IN PARTICULAR FOR A MOTOR VEHICLE

(71) Applicant: Schaeffler Technologies AG & Co. KG, Herzogenaurach (DE)

(72) Inventors: Marco Krapf, Burkardroth (DE); Miloš Falát, Kysucké Nové Mesto (SK); Andreas Kaiser, Werneck (DE); Darius Dlugai, Schwebheim (DE); Christian Mock, Schweinfurt (DE)

(73) Assignee: Schaeffler Technologies AG & Co. KG, Herzogenaurach (DE)

(21) Appl. No.: 19/138,662

(22) PCT Filed: Nov. 9, 2023
(86) PCT No.: PCT/DE2023/100847

§ 371 Date: Jun. 13, 2025

(30) Foreign Application Priority Data
Dec. 15, 2022 (DE) 10 2022 133 411.2

(51) Int. Cl. B60B 27/00; B60B 27/02; F16C 33/80

(52) U.S. Cl. CPC B60B 27/0078; B60B 27/0073; B60B 27/02; F16C 33/80; B60B 2310/616; B60B 2360/50; B60B 2900/511; F16C 2326/02

(57) ABSTRACT

The invention disclosure relates to a wheel bearing unit, in particular for a motor vehicle, having an outer ring and an inner ring, which is fixed on a wheel hub. A seal device is provided between the outer ring and the wheel hub The seal device includes at least one sealing element and one disc element. The sealing element is fastened to the outer ring and the disc element is fastened to the wheel hub. The disc element has an axial part and a radial part. On the axial part, the disc element is completely provided with a coating on a surface facing the wheel hub.

### CROSS-REFERENCE TO RELATED APPLICATIONS

This application is the U.S. National Phase of PCT Application No. PCT/DE2023/100847 filed on Nov. 9, 2023, which claims priority to DE 10 2022 133 411.2 filed on Dec. 15, 2022, the entire disclosures of which are incorporated by reference herein.

### TECHNICAL FIELD

The disclosure relates to a wheel bearing unit, in particular for a motor vehicle.

### BACKGROUND

Generic seal devices for wheel bearing units are known from the prior art. These seal devices are fixed on the wheel side between an outer ring and a wheel hub and on the transmission side between the outer ring and an inner ring pressed onto the wheel hub.

The seal devices usually consist of a sealing element and a disc element. The sealing element is fixed to the outer ring, the disc element to the wheel hub or inner ring. In this context, the sealing element and/or the disc element have sealing parts, such as sealing lips, which provide a seal between the two parts in order to prevent the ingress of dirt and water into the wheel bearing. Such seal devices are known, for example, from DE 10 2018 107 772.

The disc element can be fixed to the wheel hub in a force-fitting manner. High rotating bending torques on the wheel hub cause severe deformations in the contact zone between the wheel hub and the disc element. These deformations in the form of compression or elongation increase the risk of the disc element being set in rotational or axial motion. DE 10 2021 105 258 A1 discloses a disc element that has a rubberized seat region and a pure sheet metal seat on the flange. Here, micro-movements can be transmitted to the disc element via the wheel hub or the flange, which also sets it in axial motion. This so-called plate creep causes the disc element to move axially in the direction of the rolling elements and can damage the bearing. There are various solutions known from the prior art for preventing this plate creep. For example, the publication DE 10 2013 218 635 proposes a rim on the wheel hub that limits the axial movement.

Increasing requirements (e.g. higher loads) increase the risk of the press fit of the disc element losing its static sealing effect due to the deformation of the wheel hub or flange. Furthermore, contact corrosion can occur between the disc element and the wheel hub, as both parts are made of metal. In addition, the transmission of micro-movements of the flange of the wheel hub to the disc element should be reliably prevented in order to avoid axial movement and thus increase the service life of the bearing.

### SUMMARY

The object of the disclosure is therefore to solve these problems and ensure a long service life for the wheel bearings. In particular, axial movement of the disc element should be prevented and the sealing effect guaranteed in this regard.

This object is achieved by a wheel bearing unit according to that which is described herein.

The wheel bearing unit according to the disclosure, in particular for a motor vehicle, includes an outer ring and an inner ring, which is fixed on a wheel hub. A seal device is provided between the outer ring and the wheel hub. The seal device includes at least one sealing element and one disc element, and the sealing element is fastened or fixed to the outer ring and the disc element is fastened or fixed to the wheel hub. The disc element has an axial part and a radial part. According to the disclosure, the disc element is completely provided with a coating on the axial part of the surface facing the wheel hub.

The coating of the disc element according to the disclosure decouples the micro-movements of the flange from the disc element. This prevents axial movement of the disc element.

In an example embodiment, the coating is a polymer, in particular an elastomer. The damping properties of the polymer or elastomer prevent the transmission of vibrations to the disc element.

In principle, any basic elastomer material is suitable as a material for the sealing body. Nitrile rubber, such as NBR (nitrile butadiene rubber), is particularly suitable. Also conceivable are HNBR (hydrogenated acrylonitrile butadiene rubber), FKM (fluorocarbon rubber), ACM (polyacrylate rubber), EPDM (ethylene propylene diene (monomer) rubber) or the like. “Thermoplastic elastomers” such as TPE, TPU, TPA, etc. or even blends of the above-mentioned materials could also be used.

In an example embodiment, the radial part of the disc element on the surface facing the wheel hub is provided, in particular completely, with the coating. The coating of the disc element is provided completely on the surface facing the wheel hub, i.e., over the entire surface. The complete coating on the side facing the wheel hub results in a good material flow during production.

The coating on the axial part of the disc element can have a structure, in particular grooves. In this regard, a plurality of grooves can be provided, which are arranged at equal or irregular distances from one another. The grooves cause greater friction, which makes it more difficult to displace the disc element.

In an example embodiment, the wheel hub has a structure, such as grooves, at least in the contact region with the coating. A plurality of grooves, but at least two grooves, can be provided. The grooves can be arranged at equal or irregular distances from one another.

The grooves can be ground. Due to the grooves in the contact region of the wheel hub, the coating, in particular the elastic rubber, will deform due to the overlap in the grooves or slots. This creates a certain form fit. This makes it even easier to prevent displacement of the disc element. The structure can be introduced by grinding or an additional turning process, for example.

In an example embodiment, the coating on the axial part of the disc element has a cylindrical part and an adjoining conical part, wherein the conical part of the coating widens at an angle of between 1° and 5°. The angle refers to the horizontal plane of the surface of the wheel hub on which the disc element sits. The conical extension on the coating prevents the disc element from tilting during assembly. This improves the static fit of the disc element.

The sealing element can have at least one seal carrier and at least one sealing lip. The seal carrier can be attached to the outer ring. The sealing element can have multiple sealing lips, of which at least one sealing lip can extend in the axial direction in such a way that the sealing lip comes into contact with the disc element.

In an example embodiment, the coating further has an axial sealing lip which is in contact with a radial section of the wheel hub in the axial direction. The axial sealing lip can further prevent the ingress of dirt and water.

The wheel hub and the disc element can be connected to one another in a form-fitting and/or force-fitting manner, in particular via their structures. It is conceivable that the wheel hub has grooves that interact with complementary protrusions of the coating of the disc element. This solution could further improve the static seal seat of the disc element.

### BRIEF DESCRIPTION OF THE DRAWINGS

Further measures improving the disclosure, together with the description of the example embodiments, are described in greater detail below with reference to the figures, where identical or similar elements are provided with the same reference sign. In the figures:

FIG. 1 shows a section of a wheel bearing having a sealing arrangement according to the disclosure,

FIG. 1a shows a detailed view of a section of the disc element from FIG. 1,

FIG. 2 shows a detailed view of a section of the disc element and the wheel hub according to a second embodiment,

FIG. 3 shows a detailed view of a section of the disc element and the wheel hub according to a third embodiment,

FIG. 3a shows a detailed view of a section of the disc element and the wheel hub according to a fourth embodiment, and

FIG. 4 shows a detailed view of a section of the disc element and the wheel hub according to a fifth embodiment.

### DETAILED DESCRIPTION

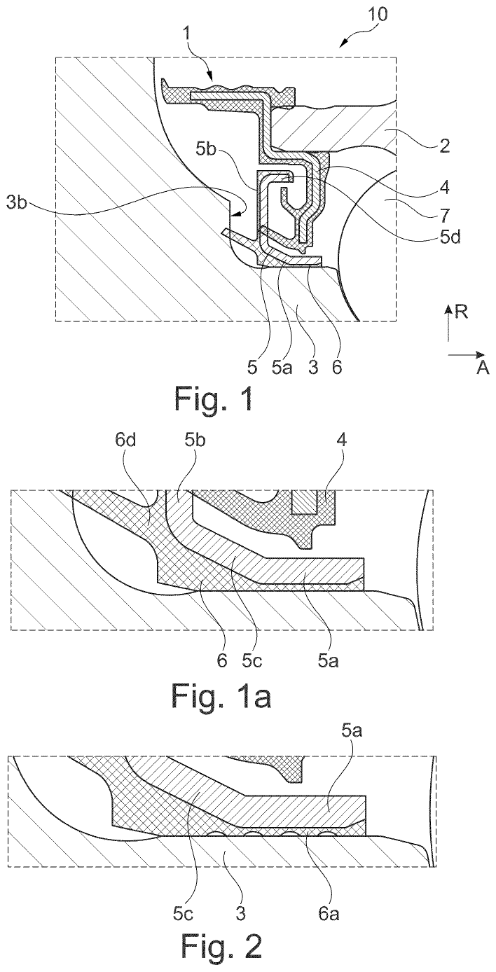

FIG. 1 shows an exemplary wheel bearing 10, in particular for a motor vehicle, having an outer ring 2 and a wheel hub 3. An inner ring, not shown, is pressed onto the wheel hub 3. At least two rows of rolling elements 7 are mounted between the outer ring 2 and the wheel hub 3. Furthermore, a seal device is provided between the outer ring 2 and the wheel hub 3 in order to prevent the ingress of dirt and water into the bearing. The seal device 1 has a sealing element 4. The sealing element 4 comprises a seal carrier that is attached to the outer ring 2. The seal carrier also has a seal comprising at least one sealing lip. The seal of the seal carrier can have at least one sealing lip that is in sliding contact with a disc element 5. The seal can have further contactless sealing lips that form a labyrinth seal. As shown in FIG. 1, the seal carrier can be fixed to the end face of the outer ring 2. The seal carrier can also comprise a sealing extension that extends in the axial direction A towards the radial section 3b of the wheel hub 3. The sealing extension can further prevent the ingress of water and dirt. It is also conceivable that the seal carrier is fixed to the outside or inside of the outer ring 2.

A disc element 5 comprises a carrier and a coating 6 applied thereto. The carrier of the disc element can be made of metal, such as sheet metal, or plastic. The disc element 5 can be designed as L-shaped. The disc element 5 has an axial part 5a and a radial part 5b, which extends in the radial direction R from the axial part 5a. The disc element 5 is pressed onto the wheel hub 3 and forms a static seal seat. The sealing lip of the sealing element 4 is in contact with the radial part 5b of the disc element 5. However, the disc element 5 can also be designed as C-shaped, wherein the disc element, in addition to the axial part 5a and the radial part 5b, also has a second axial part 5d, which extends radially between the outer ring and the axial part 5a of the disc element 5 in the direction of the sealing element 4. This second axial part 5d can also have the coating 6 on the surface facing the outer ring 2 and/or the sealing element 4.

The coating 6 of the disc element 5 is preferably formed from a polymer. The coating 6 is can be an elastomer or a rubber coating. The axial part 5a of the disc element 5 is completely coated on the surface facing the wheel hub 3. The complete coating 6 of the axial part 5a of the disc element 5 has the advantage that micro-movements transmitted by the flange of the wheel hub are damped, thus preventing an axial movement of the disc element 5. As can be seen in FIG. 1, the wheel hub 3 has a radial section 3b. The radial part 5b of the disc element 5 can be completely provided with the coating 6 on the surface facing the radial section 3b. The coating 6 also has an axial sealing lip 6d projecting from the radial part 5b, which contacts the radial section 3b of the wheel hub 3.

FIG. 1a shows the seat of the disc element 5 on the wheel hub 3 in detail. It can be seen here that the carrier of the disc element 5 is attached with its axial part 5a to a substantially cylindrical surface of the wheel hub 3. The radial part 5b adjoins the axial part 5a via an inclined or sloping transition region 5c. The region facing the wheel hub 3 of the axial part 5a, the transition region and the radial part 5b are completely provided with the coating 6.

FIG. 2 shows a second embodiment of the coating 6 on the seal device 1. The coating 6 on the axial part 5a of the disc element 5 has a structure 6a. The structure can include a plurality of grooves. A plurality of grooves is understood to mean at least two grooves. In particular, the grooves are arranged at equal distances from one another. However, it would also be conceivable for the grooves to be arranged at irregular distances from one another. As can be seen in FIG. 2, the coating 6 extends over the axial part 5a and over the transition region 5c.

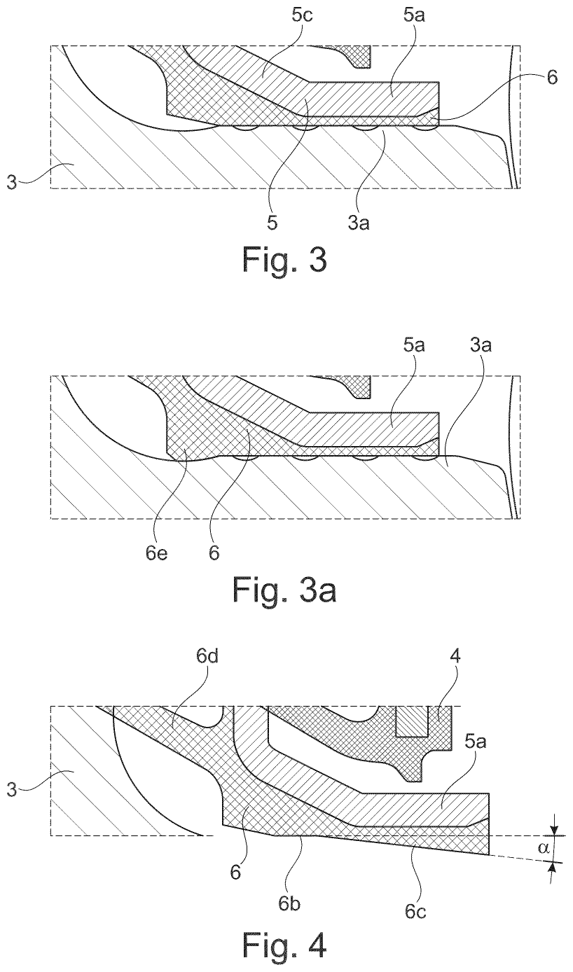

FIG. 3 shows a third embodiment of the disclosure. The disc element 5 is designed as described in FIG. 1. The wheel hub 3 has a structure 3a in the contact region with the coating of the disc element 5. The structure can, for example, be designed as a plurality of grooves. The structure is ground into the surface of the wheel hub 3.

FIG. 3a shows a structure similar to that in FIG. 3. However, an extension 6e is provided in addition to the coating 6 on the axial part 5a and in the transition region 5c. The extension 6e is can be designed as a rubber coating. The wheel hub 3 has a radius in the transition region between the contact surface with the disc element 5 and the radial section 5b. According to FIG. 3a, the extension 6e of the coating 6 is at least partially in contact with the radius of the wheel hub 3. The extension 6e serves as an additional seal and also supports the retaining function and positioning due to the form fit.

FIG. 4 shows a further embodiment according to the disclosure. The coating 6 on the disc element 5 has a cylindrical part 6b and an adjoining conical part 6c. The conical part 6c widens evenly at an angle a of between 1° and 5° in relation to the horizontal, which is substantially parallel to the axis of the wheel bearing. The conical part 6c of the coating 6 prevents the disc element 5 from tilting during assembly and ensures that the disc element 5 is securely seated.

LIST OF REFERENCE SYMBOLS
1 Seal device
2 Outer ring
3 Wheel hub
3a Structure
3b Radial section
4 Sealing element
5 Disc element
5a Axial part
5b Radial part
5c Transition region
5d Second axial part
6 Coating
6a Structure
6b Cylindrical part
6c Conical part
6d Axial sealing lip
6e Extension
7 Rolling element
A Axial direction
R Radial direction

1. A wheel bearing unit for a motor vehicle, comprising:
an outer ring,
an inner ring fixed on a wheel hub, and
a seal device disposed between the outer ring and the wheel hub, the seal device comprising:
at least one sealing element fastened to the outer ring, and
a disc element wherein the sealing element is fastened to the outer fastened to the wheel hub, the disc element having a first axial part and a radial part, and
a surface of the first axial part of facing the wheel hub is completely provided with a coating hub.

2. The wheel bearing unit according to claim 1, wherein the coating is formed from an elastomer.

3. The wheel bearing unit according to claim 2, wherein the elastomer is nitrile butadiene rubber or fluorocarbon rubber.

4. The wheel bearing unit according to claim 2, wherein a surface of the radial part facing the wheel hub is completely provided with the coating.

5. The wheel bearing unit according claim 2, wherein the coating on the first axial part has a grooves.

6. The wheel bearing unit according to claim 2, wherein the wheel hub has grooves in a contact region with the coating.

7. The wheel bearing unit according to claim 2, wherein the coating has a cylindrical part and an adjoining conical part, and the conical part of the coating widens at an angle between 1-5° degrees.

8. The wheel bearing unit according to claim 2, wherein the sealing element has at least one seal carrier and at least one sealing lip.

9. The wheel bearing unit according to claim 8, wherein the coating further has an axial sealing lip in contact with a radial section of the wheel hub (3) in an axial relative to the outer ring.

10. The wheel bearing unit according to claim 2, wherein the wheel hub and the disc element (5) are connected to one another via form-fitting and/or a force-fitting, via a groove structure arranged on the coating of the first axial part or a groove structure arranged on a region of the wheel hub that comes into contact with the coating of the first axial part.

11. The wheel bearing unit according to claim 8, wherein the at least one sealing lip is in contact with the disc element.

12. The wheel bearing unit according to claim 4, wherein the disc element further comprises a second axial part, and a surface facing the outer ring and/or the sealing element has the coating.

13. A wheel bearing unit for a motor vehicle, comprising:
an outer ring,
a wheel hub,
rolling elements mounted between the outer ring and the wheel hub,
a seal device disposed between the outer ring and the wheel hub, the seal device comprising:
a sealing element fixed to the outer ring, and
a disc element having a first axial part and a radial part, the first axial part fixed to the wheel hub, and
a surface of the first axial part of facing the wheel hub is completely provided with a coating.

14. The wheel bearing unit of claim 13, wherein the coating has a cylindrical part and an adjoining conical part arranged radially between the wheel hub and the disc element.

15. The wheel bearing unit of claim 13, wherein the coating is formed from an elastomer.

16. The wheel bearing unit of claim 15, further comprising a plurality of grooves arranged on either: i) the coating on the first axial part, or ii) on a contact region of the wheel hub that contacts the coating.

17. The wheel bearing unit of claim 16, wherein the coating further comprises an axial sealing lip that contacts a radial section of the wheel hub.

18. The wheel bearing unit of claim 17, wherein the sealing element comprises a sealing lip that contacts the radial part of the disc element.

19. The wheel bearing unit of claim 16, wherein the disc element further comprises a second axial part that forms a c-shape with the first axial part and the radial part.

20. The wheel bearing unit of claim 19, wherein the second axial part has the coating.
